(19) United States
(12) Patent Application Publication
(10) Pub. No.: US 2010/0077397 A1
(43) Pub. Date: Mar. 25, 2010

(54) Input/output (I/O) device virtualization using hardware

(76) Inventors: Giap Yong Ooi, Penang (MY); Zhan Qiang Lee, Bating (MY)

Correspondence Address: INTEL CORPORATION;c/o CPA Global, P.O. BOX 52050, MINNEAPOLIS, MN, 55402, US

(21) Appl. No.: 12/592,468

(22) Filed: Nov. 25, 2009

Related U.S. Application Data
(63) Continuation of application No. 11/528,187, filed on Sep. 26, 2006, now abandoned.

(51) Int. Cl. G06F 9/455

(52) U.S. Cl. 718/1

(57) ABSTRACT

According to embodiments of the present invention a computer system that is capable of sharing physical devices among several virtual machines (VM) includes hardware assisted logic to allow requests from guest operating systems (guest OS) to circumvent a virtual machine monitor (VMM) and be processed by the hardware assisted logic.

### REFERENCE TO RELATED APPLICATIONS

This application is related and claims priority to U.S. patent application Ser. No. 11/528,187 titled “INPUT/OUTPUT (I/O) DEVICE VIRTUALIZATION USING HARDWARE”, which was filed on Sep. 26, 2006; this application is entirely incorporated by reference.

### BACKGROUND

1. Field

Embodiments of the present invention relate to computer systems and, in particular, to using virtualization technology in computer systems.

2. Discussion of Related Art

In general, virtualization is a method of allowing the physical resources of a computing environment to be shared. Virtualization technology has been around for quite some time. However, there are still some limitations in the technology.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 is a high-level block diagram of a computing environment according to an embodiment of the present invention;

FIG. 2 is a flowchart illustrating a method of operating the computing environment depicted in FIG. 1 according to an embodiment of the present invention;

FIG. 3 is a high-level block diagram of the computing environment 100 according to an alternative embodiment of the present invention;

FIG. 4 illustrates an example structure for a packet utilized in the computing environment depicted in FIG. 3 according to an embodiment of the present invention;

FIG. 5 illustrates an example request queue utilized in the computing environment depicted in FIG. 3 according to an embodiment of the present invention

FIG. 6 illustrates an example request granted queue according to an embodiment of the present invention;

FIG. 7 is a high-level block diagram of the logic hardware according to an alternative embodiment of the present invention; and

FIG. 8 illustrates the packet depicted in FIG. 4 according to an alternative embodiment of the present invention.

### DETAILED DESCRIPTION OF EMBODIMENTS

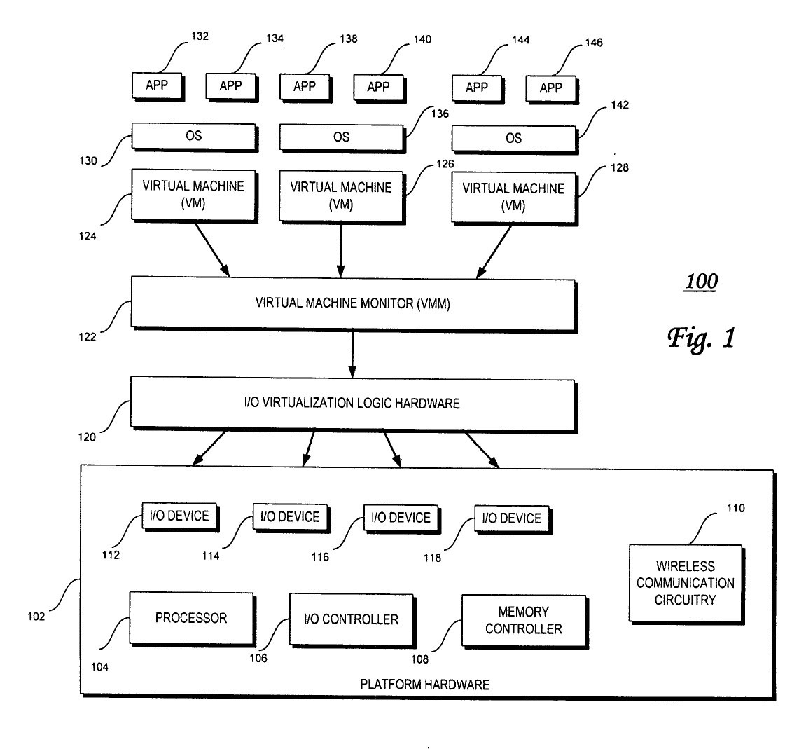

FIG. 1 is a high-level block diagram of a computing environment 100 according to an embodiment of the present invention. The illustrated environment 100 includes platform hardware 102, which includes a processor 104, an input/output (I/O) controller 106, a memory controller 108, wireless communication circuitry 110 and several I/O devices 112, 114, 116, and 118.

The illustrated platform hardware 102 is coupled to input/output (I/O) virtualization logic hardware 120. The logic hardware 120 is coupled to a virtual machine monitor (VMM) 122, which acts as a host and may have full control of the platform hardware 102. The VMM 122 may present guest software with an abstraction of a virtual processor and allow the virtual processor to execute directly on the processor 104. The VMM 122 may play the role of resource manager to allocate hardware resources in the environment 100 to virtual machines. The VMM 122 may be able to retain selective control over processor 104 resources, physical memory (not shown), interrupt management, and I/O devices 112, 114, 116, and 118.

The illustrated VMM 122 provides three virtual machines (VM) 124, 126, and 128, which are guest software environments that support a stack that includes an operating system and application software. For example, the virtual machine 124 includes a guest operating system 130 and applications 132 and 134. The virtual machine 126 includes a guest operating system 136 and applications 138 and 140. The virtual machine 128 includes a guest operating system 142 and applications 144 and 146. The virtual machines 124, 126, and 128 may operate independently of each other to access the platform hardware 102 such as the processor 104, the I/O controller 106, the memory controller 108, I/O devices 112, 114, 116, and 118, etc.

The processor 104 may be any suitable processor such as microprocessors, multiprocessors, microcomputers, and/or central processing units that perform conventional functions of executing programming instructions, including implementing the teachings of the embodiments of the present invention.

The I/O controller 106 may process commands and data to control I/O devices 112, 114, 116, and 118. The memory controller 108 may manage memory (not shown) and may control and/or monitor the status of memory data lines, error checking, etc.

Wireless communication circuitry 110 may transmit and receive data signal on carrier waves. The carrier wave may be an optical signal, a radio frequency (RF) signal, or other suitable signal in the electromagnetic spectrum.

Any of the I/O devices 112, 114, 116, and 118 may be any suitable peripheral device such as network interface cards (NICs), communication ports, video controllers, disk controllers, and the like.

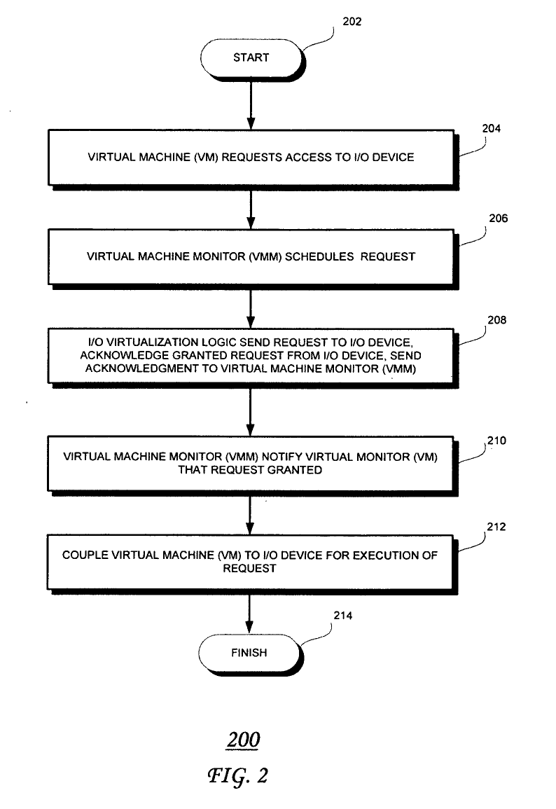

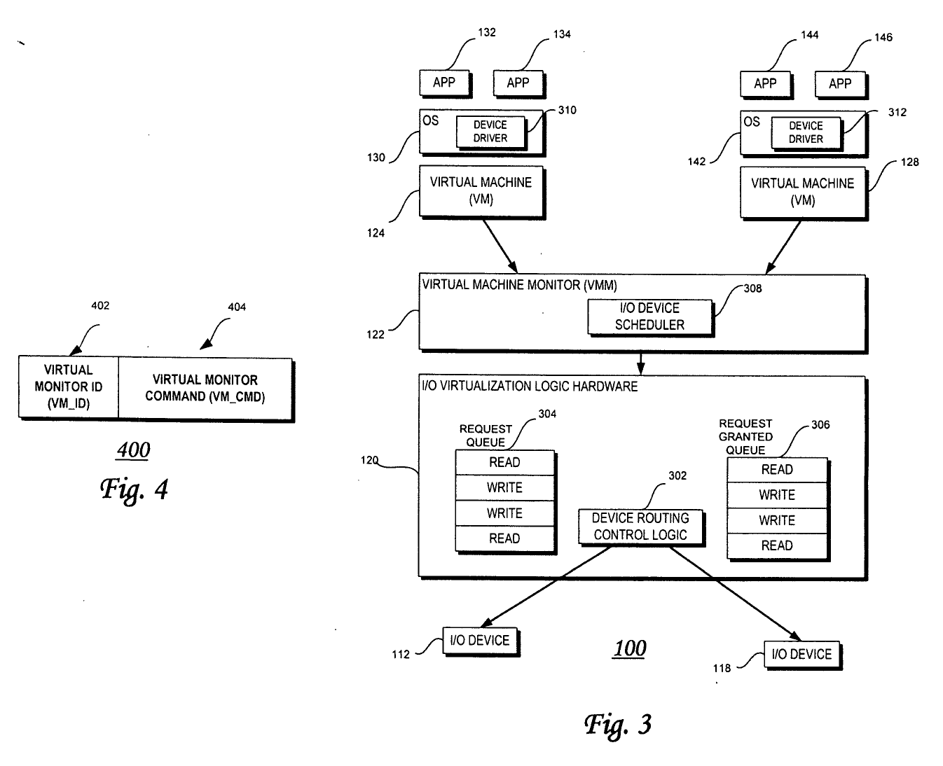

For purposes of explaining embodiments of the present invention, assume that the guest software environment of the operating system 130 and the application 132 wishes to access the I/O device 112, to read from or write to the I/O device 112, for example. FIG. 2 is a flowchart illustrating a method 200 for a guest software environment wishes to access an I/O device according to an embodiment of the present invention. The method 200 will be FIG. 3 is a high-level block diagram of the computing environment 100 according to an alternative embodiment of the present invention.

In the illustrated embodiment, the I/O devices 112 and 118 are coupled to device routing control logic 302 in the logic hardware 120. The logic hardware 120 also includes a request queue 304 and a request granted queue 306. The VMM 122 includes an I/O device scheduler 308. The OS 130 includes a non-emulated device driver 310 and the OS 142 includes a non-emulated device driver 312.

The method 200 begins with block 202, in which control passes to block 204.

In block 204, the virtual machine 124 issues a request instruction to access the I/O device 112. The request instruction may be decoded and passed to the I/O device scheduler 308 in the VMM 122. For some embodiments, the device drivers 312 and 312 may translate the request instruction from an operating system input/output request call to a system dependent or native input/output call.

In block 206, the VMM 122 may schedule the request to determine access priority to the I/O device 112. The VMM 122 may place request into packet form. The packet may have a structure indicated in FIG. 4. For example, FIG. 4 shows a packet 400 having a section 402 for a virtual machine identification (VM_ID) and a section 404 for a virtual machine command (VM_CMD) according to an embodiment of the present invention. The virtual machine identification (VM_ID) indicates the virtual monitor that originated the request and the virtual machine command (VM_CMD) indicates the requested action. In keeping with the example, the packet would have the VM_ID of 124 and the VM_CMD of READ. The I/O device scheduler 308 in the VMM 122 may pass the packet to the request queue 304 in the logic hardware 120.

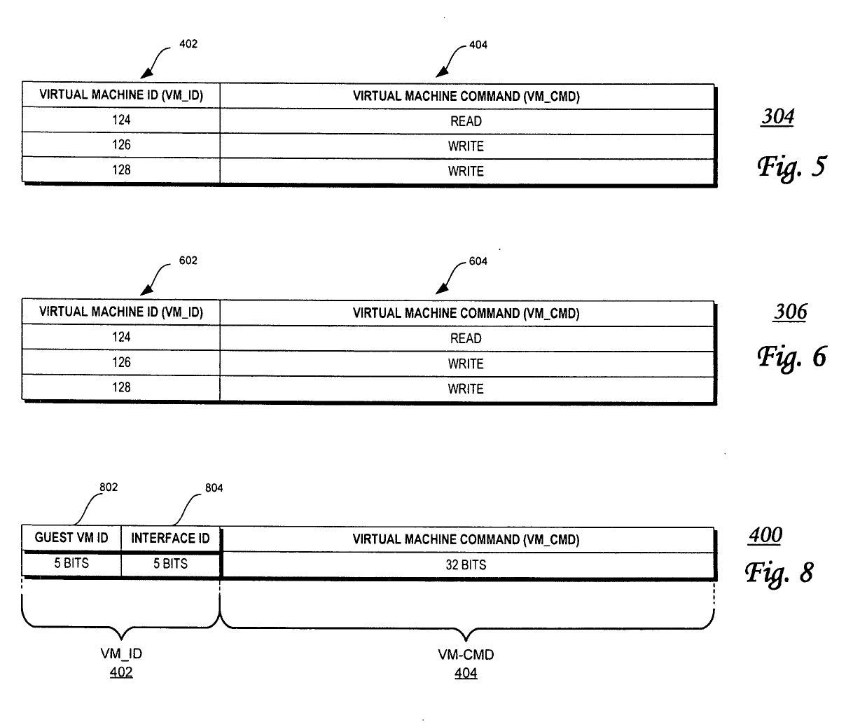

FIG. 5 shows an example request queue 304 according to an embodiment of the present invention. The request queue 304 may be any suitable buffer capable of temporarily storing entries. For some embodiments, the request queue 304 may store all I/O requests that are yet to be granted. Although only a single request queue 304 is illustrated in FIG. 3, there may be at least one request queue 304 associated with each I/O device in the computing environment 100.

The illustrated request queue 304 includes a column 402 for a virtual machine identification (VM_ID) and a column 404 for a virtual machine command (VM_CMD). In keeping with the example, the first packet stored in the request queue 304 has the VM_ID of 124 and the VM_CMD of READ indicating that the virtual monitor 124 has requested a read operation.

In block 208, the device routing control logic 302 may recognize the requested I/O device 112 from the virtual machine 124 associated with the VM_ID stored in the request queue 304 and post the VM_ID and VM_CMD to the I/O device 112. The device routing control logic 302 may continuously monitor the I/O devices of the platform hardware 102 and manage the request queues 304 and permit a virtual machine to access the I/O devices by transferring the request packet 400 from the respective request queue 304 associated with an I/O device to the request granted queue 306 based on the availability of the I/O device. The device routing control logic 302 may also schedule the to the I/O device access based on the priority of the request.

The I/O device 112 may indicate to the device routing control logic 302 that the requested access is granted. The device routing control logic 302 may generate an acknowledgement packet to indicate that that the requested access is granted. The device routing control logic 302 may post the acknowledgment packet to the request granted queue 306 in the logic hardware 120 and may send the acknowledgement packet to the I/O device scheduler 308 in the VMM 122.

For some embodiments, the device routing control logic 302 may include a scheduler (not shown) that may be responsible for granting the access to the I/O devices as requested by the guest virtual monitor using the VM_ID in the request queue 304. The scheduler may implement a round robin algorithm or other suitable algorithm.

For some embodiments, the device routing control logic 302 may define address space for the requested operation.

FIG. 6 shows an example request granted queue 306 according to an embodiment of the present invention. The request granted queue 306 may be any suitable buffer capable of temporarily storing entries. For some embodiments, the request granted queue 306 may store all I/O requests that have already been granted.

The illustrated request granted queue 306 includes a column 602 for a virtual machine identification (VM_ID) and a column 604 for a virtual machine command (VM_CMD). In keeping with the example, the first packet stored in the request granted queue 306 has the VM_ID of 124 and the VM_CMD of READ indicating that a read request from the virtual monitor 124 has been granted.

In a block 210, the VMM 122 may notify the virtual machine 124 that the request is granted and ready to be executed. For some embodiments, the I/O device scheduler 308 may use the VM_ID to route a control message to the virtual machine 124 indicating that the request is granted and ready to be executed.

In block 212, the virtual machine 124 may receive the control message and begin to perform a read operation from the I/O device 112 via a dedicated path setup between the guest operating system 130 and the I/O device 112. All subsequent packets associated with this particular request may utilize this path and the virtual machine 124 may pass remaining packets associated with this request directly to the I/O device 112 without further processing. For example, the virtual machine 124 may have direct access to the I/O device 112 without having to utilize the VMM 122 and/or logic hardware 120 for the duration of the execution of the operation. That is, communications between the OS 130 and the I/O device 112 do not have to go through the VMM 122 because the virtual machine 124 may be directly coupled to the I/O device 112 because once the I/O device scheduler 308 in the VMM 122 is aware that the request is processed by the logic hardware 120, the I/O device scheduler 308 may create a direct link to connect the virtual machine 124 to the I/O device 112. The VMM 122 may not process the same request again. The method 200 finishes in a block 214.

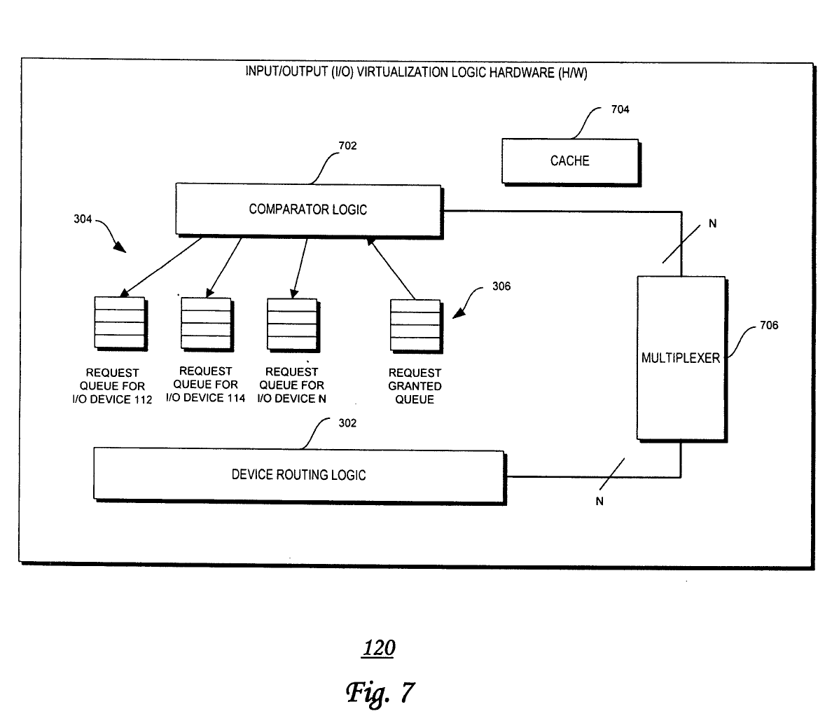

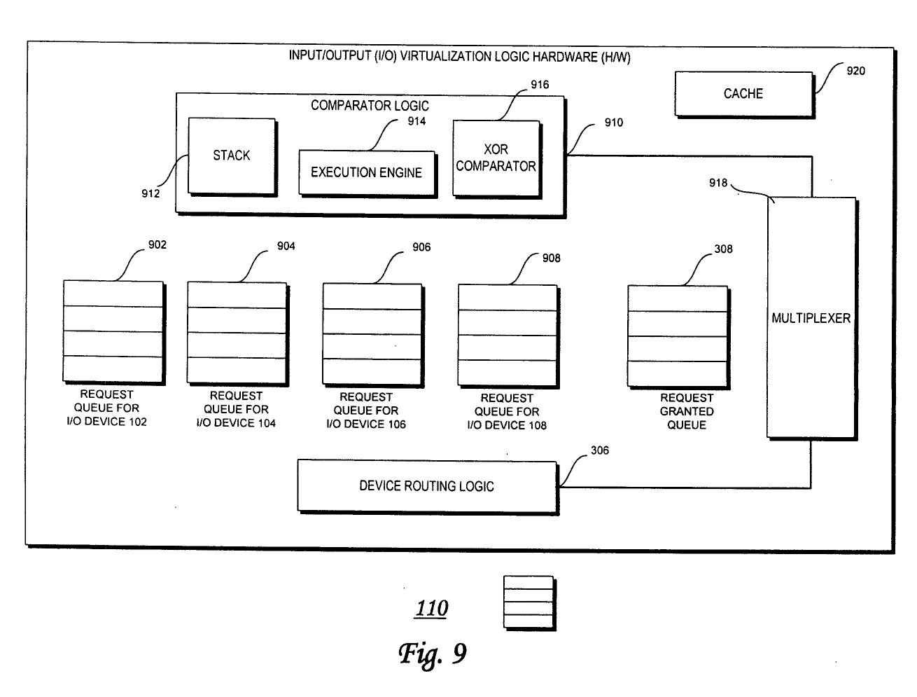

FIG. 7 is a high-level block diagram of the logic hardware 120 according to an alternative embodiment of the present invention. In the illustrated embodiment, the logic hardware 120 includes the comparator logic 702 coupled to several request queues 304, one request queue 304 for each I/O device. The comparator logic 120 also is coupled to the request granted queue 306. The logic hardware 120 also includes a cache 704 and a multiplexer 706. The multiplexer 706 is coupled to the comparator logic 702 and the device routing and control logic 302.

Operation of the logic hardware 120 is described with reference to FIG. 8, which illustrates the packet 400 in more detail according to an embodiment of the present invention. The packet 400 illustrated in FIG. 8 shows the VM_ID section 402 divided into a guest VM_ID subsection 802 and an INTERFACE ID section 804. In one embodiment, the subsections 802 and 804 each may include five bits. The VM_CMD section 404 may include 32 bits of data or instructions. With the arrangement of the packet 400 it can be seen that the computing environment 100 may support up to 32 I/O devices and/or up to 32 virtual machines in the 32 bit computing environment. The I/O devices in the hardware platform 102 may be shared across multiple virtual machines in the environment 100. The VM_ID field may be used to address to the various virtual machines. The I/O devices associated with the transaction may be addressed using the INTERFACE_ID 804.

For some embodiments, the comparator logic 702 may sort new requests for access to I/O devices from requests for access to I/O devices that have already been granted. The comparator logic 702 thus may compare the VM_ID field of an incoming packet 400 to an entry in the request granted queue 306. If an incoming packet 400 passes through the comparator logic 702 without a match, the packet 400 may be routed to its respective request queue for the particular I/O device as determined by the INTERFACE ID. If an incoming packet 400 passes through the comparator logic 702 and finds a match in the request granted queue 306, the packet 400 may be routed to its particular I/O device as determined by the INTERFACE ID. For some embodiments, the comparator logic 702 may include an execution engine (not shown), a stack (not shown), and a comparator (not shown) to sort out the new I/O requests and granted requests.

For some embodiments, the cache 704 may latch the most recently granted I/O access packet. Some processes executing within the computing environment 100 with higher priority may interrupt the operation of the currently executing process. In one embodiment, the cache 704 may latch the most recently granted I/O access packet and the computing environment 100 may skip having to search for a match from the request granted queue 306. Instead, the computing environment 100 may look in the cache for the most recently granted I/O access packet.

The multiplexer 706 may compare the two inputs from the comparator logic 702 and the device routing logic 302 and route the request queue to the particular I/O device based on the INTERFACE ID. Note that in the illustrated embodiment, the INTERFACE ID section 804 includes five bits. In this embodiment, the computing system 100 may support up to 32 I/O devices.

If the VM_ID field of a selected packet from a request queue 304 matches VM_ID field of a selected packet from the request granted queue 306, then the comparator logic 702 outputs a signal to the multiplexer 706 to indicate that there is a “hit.” The multiplexer 706 uses the input from the comparator logic and the INTERFACE ID of the packet in the queue 304 entry as provided by the device routing logic 302 to route the packet to the appropriate interface.

If the VM_ID field of a selected packet from a request queue 304 does not match the VM_ID field of the selected packet from the request granted queue 306, because the request has not already been granted, for example, then the comparator logic 702 may skip the request until the next subsequent request for access to an I/O device.

Embodiments of the present invention may be implemented using hardware, software, or a combination thereof. In implementations using software, the software or machine-readable data may be stored on a machine-accessible medium. The machine-readable data may be used to cause a machine, such as, for example, a processor (not shown) to perform the method 200.

A machine-readable medium includes any mechanism that may be adapted to store and/or transmit information in a form accessible by a machine (e.g., a computer, network device, personal digital assistant, manufacturing tool, any device with a set of one or more processors, etc.). For example, a machine-readable medium includes recordable and non-recordable media (e.g., read only (ROM), random access (RAM), magnetic disk storage media, optical storage media, flash devices, etc.), such as electrical, optical, acoustic, or other form of propagated signals (e.g., carrier waves, infrared signals, digital signals, etc.).

In the above description, numerous specific details, such as, for example, particular processes, materials, devices, and so forth, are presented to provide a thorough understanding of embodiments of the invention. One skilled in the relevant art will recognize, however, that the embodiments of the present invention may be practiced without one or more of the specific details, or with other methods, components, etc. In other instances, structures or operations are not shown or described in detail to avoid obscuring the understanding of this description.

Reference throughout this specification to “one embodiment” or “an embodiment” means that a particular feature, structure, process, block, or characteristic described in connection with an embodiment is included in at least one embodiment of the present invention. Thus, the appearance of the phrases “in one embodiment” or “in an embodiment” in various places throughout this specification does not necessarily mean that the phrases all refer to the same embodiment. The particular features, structures, or characteristics may be combined in any suitable manner in one or more embodiments.

The terms used in the following claims should not be construed to limit embodiments of the invention to the specific embodiments disclosed in the specification and the claims. Rather, the scope of embodiments of the invention is to be determined entirely by the following claims, which are to be construed in accordance with established doctrines of claim interpretation.

What is claimed is:

1. A method, comprising:
a device driver, residing in a guest operating system on a first virtual machine, receiving a request to access an input/output (I/O) device;
the device driver translating the request to a native I/O call to the I/O device; and
the device driver routing the translated request directly to the I/O device.

2. The method of claim 1, wherein routing the translated request directly to the I/O device comprises bypassing processing of the request by a virtual machine monitor.

3. The method of claim 1, further comprising:
receiving one or more additional requests to access the I/O device;
translating the one or more additional requests;
queuing the one or more additional requests in a buffer;
granting I/O device access to the request with the highest priority; and
forwarding the request with granted access to the I/O device.

4. A device, comprising:
logic to allow a first virtual machine to directly access an I/O device through a given I/O access request without a virtual machine monitor processing the given I/O access request;
a request queue to store the given I/O access request from the first virtual machine for the I/O device.

5. The device of claim 4, wherein the request queue additionally stores one or more other I/O access requests from one or more other virtual machines.

6. The device of claim 5, wherein the logic is further operable to:
determine which I/O access request in the request queue is to be granted; and
send the determined I/O access request from request queue to the I/O device.

7. A system, comprising:
an I/O device;
a system memory, the system memory to store at least one virtual machine environment;
a virtual machine monitor;
logic to allow a first virtual machine of the at least one virtual machine to directly access the I/O device through a given I/O access request without the virtual machine monitor processing the given I/O access request; and
a request queue to store the given I/O access request from the first virtual machine for the I/O device.

8. The system of claim 7, wherein the system memory is further operable to store at least one guest operating system and one device driver.

9. The system of claim 8, wherein the device driver is operable to:
receive an I/O request to the I/O device;
translate the I/O request to a native I/O call; and
send the translated native I/O call to the I/O device.

10. The system of claim 9, wherein the virtual machine monitor is operable to:
prior to the direct access of the I/O device by the first virtual machine,
receive an initial I/O access request to the I/O device from the first virtual machine; and
grant the initial I/O access request by allowing the first virtual machine direct access to the I/O device using the device driver for any subsequently received I/O access requests.
